(19) United States
(12) Patent Application Publication
(10) Pub. No.: US 2023/0061504 A1
(43) Pub. Date: Mar. 2, 2023

(54) Laser Lane Keeping Device

(71) Applicant: Steven Dixon, Cincinnati, OH (US)

(72) Inventor: Steven Dixon, Cincinnati, OH (US)

(21) Appl. No.: 17/892,510

(22) Filed: Aug. 22, 2022

Related U.S. Application Data
(60) Provisional application No. 63/236,770, filed on Aug. 25, 2021.

(51) Int. Cl. B60W 30/12; B60W 40/10

(52) U.S. Cl. CPC B60W 30/12; B60W 40/10; B60W 2420/62

(57) ABSTRACT

The present invention relates generally to the field of lane-keeping devices. More specifically, the present invention relates to a device that is primarily comprised of a housing, further comprised of at least one button, at least one laser emitter, a battery, and a light sensor. Further, the device is comprised of a bottom wall, further comprised of at least one fastener. The device is also comprised of a top wall that may be comprised of a solar panel to power the device. Further, the device, via laser emitter, emits a light beam directed out in front of the vehicle onto the roadway. The light beam shown on the roadway allows the driver of the vehicle to know precisely where in the lane their vehicle is located. The device further allows for the light emitter to be changed to encompass an array of different intensities and distances.

### CROSS-REFERENCE TO RELATED APPLICATION

The present application claims priority to, and the benefit of, U.S. Provisional Application No. 63/236,770, which was filed on Aug. 25, 2021, and is incorporated herein by reference in its entirety.

### FIELD OF THE INVENTION

The present invention relates generally to the field of lane-keeping devices. More specifically, the present invention relates to a device that is primarily comprised of a housing, further comprised of at least one button, at least one laser emitter, a battery, and a light sensor. Further, the device is comprised of a bottom wall, further comprised of at least one fastener. The device is also comprised of a top wall that may be comprised of a solar panel to power the device. Further, the device, via laser emitter, emits a light beam directed out in front of the vehicle onto the roadway. The light beam shown on the roadway allows the driver of the vehicle to know precisely where in the lane their vehicle is located. Accordingly, the present disclosure makes specific reference thereto. Nonetheless, it is to be appreciated that aspects of the present invention are also equally applicable to other like applications, devices, and methods of manufacture.

### BACKGROUND

By way of background, operating a motor vehicle presents many dangers to both the driver of the vehicle and other drivers on the road. One of the more difficult parts of driving a motor vehicle is keeping track of where in the lane the vehicle is positioned. Driving a motor vehicle too far in either direction of the lane can cause the vehicle to collide with other motorists or to drive off the road. Headlights from oncoming vehicles can cause drivers to be disoriented and veer out of their road lane. Tight lanes and winding roads in the dark can put significant stress on drivers causing them to veer into different lanes. As a result, all mentioned dangers of driving have left drivers feeling less confident and unsafe.

Therefore, there exists a long-felt need in the art for an affordable and easy-to-use device that can help drivers safely stay in the center of their lane. There also exists a long-felt need in the art for a device that helps prevent drivers from veering out of their lane. There also exists a long-felt need in the art for a way for drivers to stay in their lane driving through tight, winding roads more accurately at night. Further, there exists a long-felt need in the art for a device that allows drivers to drive with more confidence and in a safer manner.

The subject matter disclosed and claimed herein, in one embodiment thereof, comprises a laser lane-keeping device. The device is primarily comprised of a housing, further comprised of at least one button, at least one laser emitter, a battery, and a light sensor. Further, the device is comprised of a bottom wall, further comprised of at least one fastener. The device is also comprised of a top wall that may be comprised of a solar panel to power the device. Further, the device, via laser emitter, emits a light beam directed out in front of the vehicle onto the roadway. The light beam shown on the roadway allows the driver of the vehicle to know precisely where in the lane their vehicle is located.

In this manner, the laser lane-keeping device of the present invention accomplishes all of the foregoing objectives and provides a device that assists users while driving by clearly showing where in the lane the vehicle is. By allowing a user to see where their vehicle is in the lane, a user is much less likely to veer into oncoming traffic, or off the roadway and into a ditch. The device also helps a user to not get distracted or disoriented by oncoming traffic which can lead to a driver veering out of their lane. As well as the device allows users to navigate curved tight roads in the dark.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a laser lane-keeping device. The device is primarily comprised of a housing, further comprised of at least one button, at least one laser emitter, a battery, and a light sensor. Further, the device is comprised of a bottom wall, further comprised of at least one fastener. The device also has a top wall that may be comprised of a solar panel to power the device.

Further, the device emits a light beam directed out in front of the vehicle and onto the roadway. The light beam shown on the roadway allows the driver of the vehicle to know precisely where in the lane their vehicle is located. The device further allows for the light emitter to be changed to encompass an array of different intensities and distances allowing users to use the device in a variety of different-size vehicles and weather conditions.

In one embodiment, the device may be controlled by a user's smart device via a mobile application. A user may use their smart device via a mobile application to turn the device on/off and change light beam intensities or angles. The device may be comprised of a transmitter that is in electrical communication with the mobile application to allow the user to control the device remotely.

Accordingly, the laser lane keeping device of the present invention is particularly advantageous as it allows a user to operate their motor vehicle safer and with more confidence. Further, the device prevents drivers from veering off to the right into ditches or left into oncoming traffic. The device also allows users to safely drive narrow roads at night without the stress of trying to stay in their lane. In this manner, the laser lane keeping device overcomes the limitations of existing lane keeping devices known in the art.

Numerous benefits and advantages of this device will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a laser lane keeping device of the present invention while attached to a semi-truck body in accordance with the disclosed architecture; and

FIG. 2 illustrates a perspective view of one potential embodiment of a laser lane keeping device of the present invention while attached to a semi-truck body and producing a light beam onto a roadway in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an affordable and easy-to-use device that can help drivers safely stay in the center of their lane. There also exists a long-felt need in the art for a device that helps prevent drivers from veering out of their lane, leading to accidents. There also exists a long-felt need in the art for a way for drivers to stay in their lane driving through tight, winding roads at night. Further, there exists a long-felt need in the art for a device that allows drivers to drive feeling more confident and safer.

The present invention, in one exemplary embodiment, is comprised of a laser lane-keeping device. The device is primarily comprised of a housing, further comprised of at least one battery, at least one laser emitter, a battery, and a light sensor. Further, the device is comprised of a bottom wall, further comprised of at least one fastener. The device is also comprised of a top wall that may be comprised of a solar panel to power the battery which powers the device.

During use, the device emits a light beam directed out in front of the vehicle onto the roadway. The light beam shown on the roadway allows the driver of the vehicle to know precisely where in the lane their vehicle is located. The device further allows for the light emitter to be changed to encompass an array of different intensities and distances. This allows for the device to be applied to different-size vehicles and differentiating levels of darkness.

In one embodiment, the device may be controlled by a user's smart device via a mobile application. A user may use their smart device via a mobile application to turn the device on/off and change light beam intensities or angles. The device may be comprised of a transmitter that is in electrical communication with the mobile application allowing the user to control the device remotely.

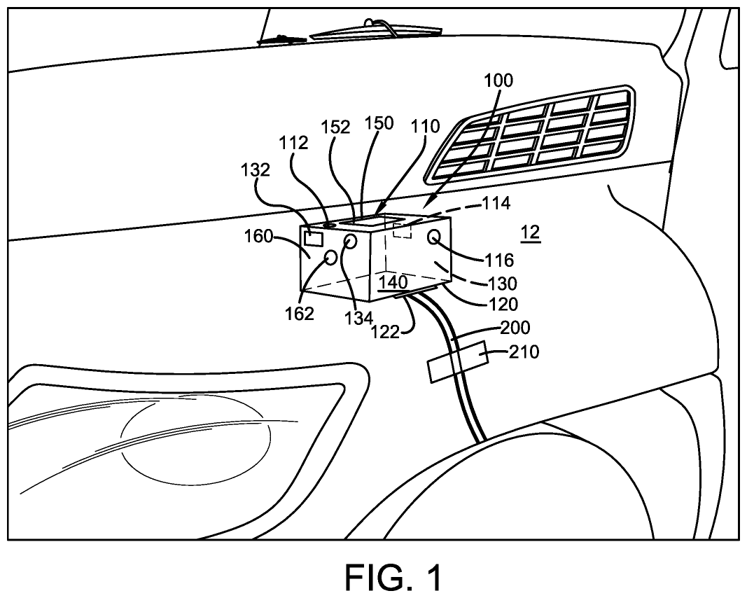

Referring initially to the drawings, FIG. 1 illustrates a perspective view of one potential embodiment of a laser lane-keeping device 100 of the present invention while attached to a semi-truck body 12 in accordance with the disclosed architecture. The device 100 is primarily comprised of a housing 110, further comprised of at least one battery 114, at least one laser emitter 162, and at least one light sensor 112. Further, the housing 110 has a bottom wall 120, further comprised of a fastener 122 that allows the device 100 to attach to a semi-truck body 12. The housing 110 also has a top wall 150 that may have at least one solar panel 152 positioned on top of it to power the device 100.

The housing is preferably comprised of a top wall 150, a bottom wall 120, at least one side wall 140, and a front wall 160. The housing 110 may be made from a plurality of materials such as, but not limited to, plastic, metal, or any other suitable material as is known in the art. In the preferred embodiment, the housing 110 is made from any plastic such as, but not limited to: acrylic, polycarbonate, polyethylene, thermoplastic, acrylonitrile butadiene styrene, low-density polyethylene, medium density polyethylene, high-density polyethylene, polyethylene terephthalate, polyvinyl chloride, polystyrene, polylactic acid, acetal, nylon, fiberglass, etc. The housing 110 may also be any shape that is known in the art, such as, but not limited to, rectangular, spherical, square, cylindrical, etc.

In the preferred embodiment, the device 100 may have at least one button 116 located on the housing 110. In one embodiment, the device 100 may have just one button 116 that turns the device 100 off and on. In another embodiment, the device 100 may have a plurality of buttons 116 that control different functions such as, but not limited to, changing the distance the light beam 170 travels in front of the vehicle, the intensity of the light beam 170, powering on/off the device 100, etc. Further, in the preferred embodiment the device 100 is comprised of at least one light sensor 112. When the light sensor 112 detects a lack of light below a threshold level (i.e., dusk/dawn), the light sensor 112 automatically powers on the device 100. There are a plurality of light sensors 112 that can be used such as, but are not limited to, photovoltaic cells, photo-resisters, photodiodes, phototransistors, etc.

In one embodiment, the device 100 may be comprised of at least one transmitter 180. The transmitter 180 is further in electrical communication with a mobile application 190 allowing a user to operate the device 100 remotely via a smart device such as, but not limited to, a smartphone. The mobile application 190 allows a user to turn the device 100 on and off, as well as it allows a user to adjust the intensity of the light beam 170. This allows a user to control the device 100 and change the intensities of the beam 170 as weather conditions change. This prevents the need to get out of the vehicle and manually change the intensities of the device 100. In different embodiments, the electronic communication capabilities of the device 100 could be, but are not limited to, GPS, WIFI, Bluetooth, RFID, cellular, etc.

Further, the transmitter 180 is powered by at least one battery 182. The battery 182 can be in the form of an alkaline, nickel-cadmium, nickel-metal hydride battery, etc., such as any 3V-12-volt DC battery 182 or other conventional battery 182 such as A, AA, AAA, etc., that supplies power to the transmitter 180. Throughout this specification the terms “battery” and “batteries” may be used interchangeably to refer to one or more wet or dry cells or batteries 182 of cells in which chemical energy is converted into electricity and used as a source of DC power. References to recharging or replacing batteries 182 may refer to recharging or replacing individual cells, individual batteries 182 of cells, or a package of multiple battery cells as is appropriate for any given battery 182 technology that may be used.

In one embodiment, the device 100 may be comprised of at least one lever 132 that allows the laser emitter 162 to be moved to emit the light beam 170 at the appropriate distance and angle that the user wishes. Further, the lever 132 allows the user to direct the light beam 170 in different directions without having to move the entire device.

In another embodiment, the device 100 may be comprised of at least one dial 174 that can be used to move the laser emitter 162 to direct the light beam 170 in a multitude of angles and directions. This allows the user to change the angles and directions for any size vehicle without moving the entire device.

The device 100 is further comprised of at least one battery 114. The battery 114 can be in the form of an alkaline, nickel-cadmium, nickel-metal hydride battery, etc., such as any 3V volt DC battery 114 or other conventional battery 114 such as A, AA, AAA, etc., that supplies power to the device 100. Throughout this specification the terms “battery” and “batteries” may be used interchangeably to refer to one or more wet or dry cells or batteries 114 of cells in which chemical energy is converted into electricity and used as a source of DC power. References to recharging or replacing batteries 114 may refer to recharging or replacing individual cells, individual batteries 114 of cells, or a package of multiple battery cells as is appropriate for any given battery 114 technology that may be used. Further, in the preferred embodiment, the device 100 may have a solar panel 152 located on the top wall 150 that provides power to the battery 114 to power the device 100. The solar panel 152 may be any suitable solar panel 152 technology that is known in the art. The solar panel 152 allows for the battery 114 to be recharged so the user does not have to change the battery 114 or recharge the device 100 manually.

The device 100 further is comprised of at least one fastener 122 that can be located on the housing 110 but is preferably located on the bottom wall 120 of the device 100. The fastener 122 may be any fastener 122 that is known in the art such as, but not limited to, suction cup, adhesive, magnetic, bolt, screw, etc. In the preferred embodiment, the device 100 is attached to both sides of the vehicle via a suction cup fastener 122. In another embodiment, the device 100 can be attached to the mirrors of the vehicle via at least one strap 200. The strap 200 goes around the mirror of the vehicle and is fastened via at least one fastener 210. There may be a plurality of fasteners 210 such as, but not limited to, hook and loop, snap button, buckle, etc. This allows the device 100 to be attached to a greater multitude of vehicles in a variety of ways. Smaller vehicles and users that do not want to place the device 100 on the body of their vehicle can discreetly place the device 100 on their side mirrors via straps 200.

The device 100 is further comprised of at least one laser emitter 162 that is preferably located on the front wall 160 of the device 100. The laser emitter 162 directs at least one light beam 170 to the roadway 10 in front of the vehicle allowing the user to clearly see where their vehicle is located in their respective lane. The laser emitter 162 may be any laser emitter 162 that is known in the art. The laser emitter 162 may emit any visible light laser such as, but not limited to, red, green, blue, yellow, etc.

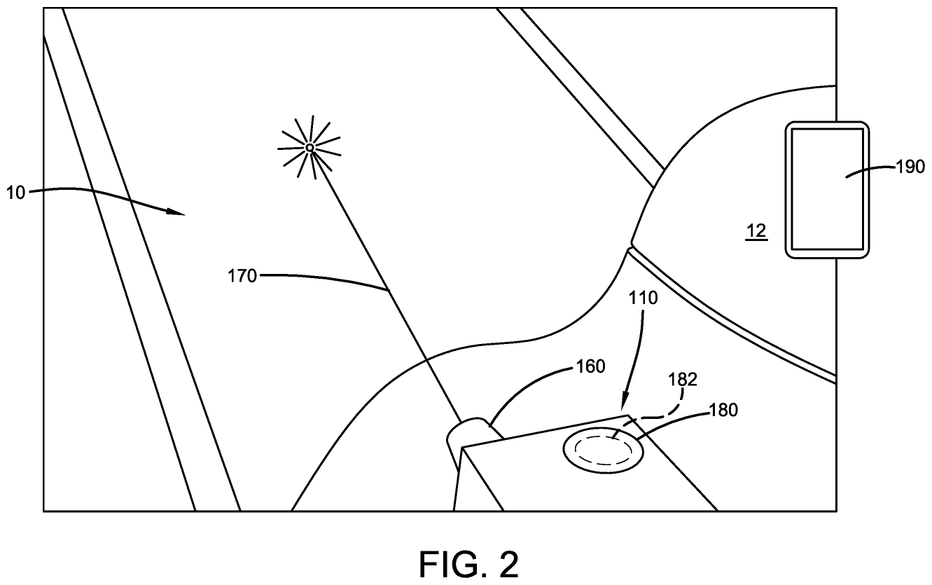

FIG. 2 illustrates a perspective view of one potential embodiment of a laser lane keeping device 100 of the present invention while attached to a semi-truck body 12 and producing a light beam 170 onto a roadway 10 in accordance with the disclosed architecture. The laser emitter 162 located on the front wall 160 of the device 100 emits a light beam 170 that allows the user to know where the vehicle is in the roadway 10. The light beam 170 that is emitted can be a multitude of intensities as well as distances. Being able to change the distances allows for the device 100 to be fastened 160 to a plurality of different types of vehicles such as, but not limited to, semi-truck, SUVs, sedan, pick-up trucks, etc. Changing the intensity of the light beam 170 will allow a user to view the light beam no matter the weather.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “laser lane keeping device” and “device” are interchangeable and refer to the laser lane keeping device 100 of the present invention.

Notwithstanding the foregoing, the laser lane keeping device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the laser lane keeping device 100 as shown in the FIGS. are for illustrative purposes only, and that many other sizes and shapes of the laser lane keeping device 100 are well within the scope of the present disclosure. Although the dimensions of the laser lane keeping device 100 are important design parameters for user convenience, the laser lane keeping device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A laser lane-keeping device comprising:
a housing;
a fastener;
a laser emitter; and
a battery.

2. The laser lane keeping device of claim 1, wherein the fastener is a suction cup.

3. The laser lane keeping device of claim 1 further comprised of a button.

4. The laser lane keeping device of claim 3, wherein the button controls a function of the laser emitter.

5. A laser lane-keeping device comprising:
a housing;
a first fastener;
a solar panel;
a strap having a second fastener;
a light sensor;
a dial;
a laser emitter; and
a battery.

6. The laser lane keeping device of claim 5, wherein the solar panel charges the battery.

7. The laser lane keeping device of claim 5, wherein the battery provides power to the laser emitter.

8. The laser lane keeping device of claim 5, wherein the light sensor automatically activates the laser emitter when an amount of light below a threshold value is detected.

9. The laser lane keeping device of claim 5, wherein the first fastener is a bolt fastener.

10. The laser lane keeping device of claim 5, wherein the light sensor is a photo-resister.

11. The laser lane keeping device of claim 6, wherein the solar panel is positioned on a top wall of the housing.

12. A laser lane-keeping device comprising:
a housing;
a fastener;
a light sensor;
a dial;
a transmitter;
a mobile application;
a laser emitter; and
a battery.

13. The laser lane keeping device of claim 12, wherein the transmitter is in wireless electrical communication with the mobile application.

14. The laser lane keeping device of claim 13, wherein the mobile application allows a user to change an intensity of the laser emitter.

15. The laser lane keeping device of claim 12, wherein the dial allows a user to change a distance of the laser emitter.

16. The laser lane keeping device of claim 12, wherein the laser emitter emits a colored light beam.

17. The laser lane keeping device of claim 12, wherein the fastener is a magnetic fastener.

18. The laser lane keeping device of claim 12 comprised of a level that allows a user to change an angle of the laser emitter.

19. The laser lane keeping device of claim 12, wherein the light sensor is a photovoltaic cell.

20. The laser lane keeping device of claim 12, wherein the transmitter is powered by a second battery.
